(19) United States
(12) Patent Application Publication
(10) Pub. No.: US 2016/0092086 A1
(43) Pub. Date: Mar. 31, 2016

(54) HANDHELD ELECTRONIC DEVICE AND SETTING MENU ACCESS METHOD OF THE SAME

(71) Applicant: HTC Corporation, Taoyuan County (TW)

(72) Inventor: Chien-Liang LIN, Taoyuan County (TW)

(21) Appl. No.: 14/501,016

(22) Filed: Sep. 29, 2014

(51) Int. Cl. G06F 3/0484; G06F 3/0481; G06F 3/0488; G06F 3/0482

(52) U.S. Cl. CPC G06F 3/04847; G06F 3/0482; G06F 3/04817; G06F 3/04842; G06F 3/04883

(57) ABSTRACT

A handheld electronic device is provided. The handheld electronic device includes a storage unit, a touch display unit and a processing unit. The storage unit stores pieces of associating data each associating one of applications with corresponding setting options. The touch display unit receives a setting menu accessing command. The processing unit executes an active application of the applications, retrieves one piece of the associating data related to the active application in response to the setting menu accessing command and control the touch display unit to display a setting menu including only the corresponding setting options associated with the active application.

### BACKGROUND

1. Field of Invention

The present invention relates to an operation technology of an electronic device. More particularly, the present invention relates to a handheld electronic device and a setting menu access method of the same.

2. Description of Related Art

Handheld electronic devices are essential communication tools for people in the daily life for most people. Besides the ability of communication, the handheld electronic devices are equipped with increasing abilities of data operation and data processing. The combination of the data operation ability and the communication ability makes the handheld electronic devices such as the tablet PCs or the smartphones reminiscent to small computers. It is convenient to edit documents, navigate the network, receive e-mails and deliver e-mails by using the handheld electronic devices.

Similar to the condition of operating a normal computer, the user may change the settings of the handheld electronic devices such that the handheld electronic devices operate in favor of the user. However, the menu of the setting options is often too complex for the user to operate. The user may get lost and may not be able to find the correct options in the menu.

Accordingly, what is needed is a handheld electronic device and a setting menu access method of the same to address the issues mentioned above.

### SUMMARY

An aspect of the present invention is to provide a handheld electronic device. The handheld electronic device includes a storage unit, a touch display unit and a processing unit. The storage unit stores a plurality pieces of associating data each associating one of a plurality of applications with a plurality of corresponding setting options. The processing unit executes an active application of the plurality of applications, determines that the touch display unit receives a setting menu accessing command, retrieves one piece of the associating data related to the active application in response to the setting menu accessing command and controls the touch display unit to display a setting menu including only the corresponding setting options associated with the active application.

A setting menu access method used in a handheld electronic device. The setting menu access method includes the steps outlined below. A plurality pieces of associating data each associating one of a plurality of applications with a plurality of corresponding setting options are stored by a storage unit. An active application of the plurality of applications is executed by a processing unit. A setting menu accessing command is determined to be received by a touch display unit by the processing unit. One piece of the associating data related to the active application is retrieved in response to the setting menu accessing command by the processing unit. The touch display unit is controlled to display a setting menu including only the corresponding setting options associated with the active application by the processing unit.

These and other features, aspects, and advantages of the present invention will become better understood with reference to the following description and appended claims.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1A is a block diagram of a handheld electronic device in an embodiment of the present invention;

FIG. 1B and FIG. 1C are top views of the handheld electronic device in FIG. 1A in an embodiment of the present invention;

FIG. 2 is a top view of the handheld electronic device in FIG. 1A in an embodiment of the present invention; and

FIG. 3 is flow chart of a setting menu access method of an embodiment of the present invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

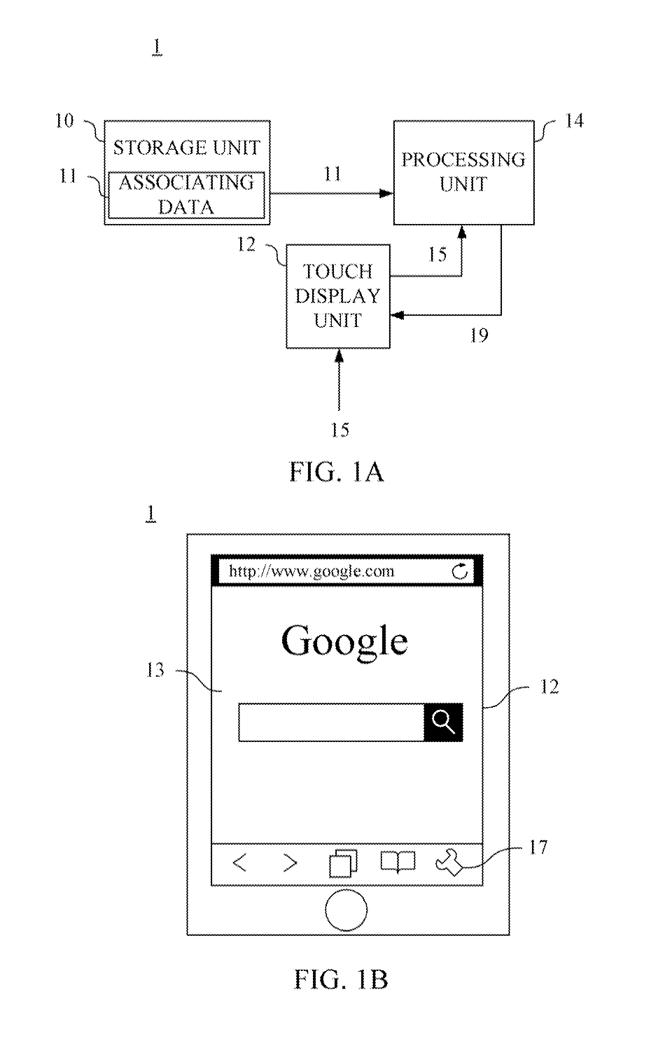

FIG. 1A is a block diagram of a handheld electronic device 1 in an embodiment of the present invention. FIG. 1B and FIG. 1C are top views of the handheld electronic device 1 in FIG. 1A in an embodiment of the present invention. The handheld electronic device 1 includes a storage unit 10, a touch display unit 12 and a processing unit 14.

The storage unit 10 stores a plurality pieces of associating data 11. Each pieces of the associating data 11 associates one of a plurality of applications with a plurality of corresponding setting options. In an embodiment, the applications can be stored in the storage unit 10 too.

In an embodiment, the corresponding setting options are associated with the corresponding application according to a hardware access authority of the application. For example, a web browser application is used to access the network through a network module (not shown) in the handheld electronic device 1 and store the related data, such as the cookies or security information in a storage module, such as the storage unit 10 illustrated in FIG, 1A. As a result, the web browser application has the authority to access the network module and the storage module, and can be associated with the setting options including a network connection setting option, a privacy setting option, a security setting option, a cookies setting option or a combination of the above.

Take the media player application for another example. The media player application is used to playback the multimedia data through a sound playback module (not illustrated) and a display module, such as the touch display unit 12 illustrated in FIG. 1A. As a result, the application of a media player has the authority to access the sound playback module and the display module, and can be associated with the setting options including a equalizer setting option, a media information setting option, a playback setting option or a combination of the above.

In an embodiment, the corresponding setting options include at least one universal setting option. The universal setting option is related to the settings that affect the operation status of the whole handheld electronic device 1 and may include a brightness setting option, a volume setting option, a device operation mode setting or a combination of the above.

The touch display unit 12 displays frames based on different operation conditions f the handheld electronic device 1. In an embodiment, the touch display unit 12 displays the frames according to the display data transmitted by the processing unit 14. The processing unit 14 is electrically connected to the storage unit 10 and the touch display unit 12. In an embodiment, the processing unit 14 is able to access the storage unit 10, perform processing according to the input of the touch display unit 12 and output the operation result such that the touch display unit 12 displays the result.

In an embodiment, the processing unit 14 executes an active application (not illustrated) of the plurality of applications such that the touch display unit 12 displays an interface 13 of the active application, as illustrated in FIG. 1B.

The processing unit 14 determines that whether the touch display unit 12 receives a setting menu accessing command 15. In an embodiment, the touch display unit 12 receives the setting menu accessing command 15 by receiving an operation input applied on an icon, such as the tool icon 17 illustrated in FIG, 1B of the interface 13. In embodiment, the operation input is performed by a touch object (not illustrated) such as, but not limited to a finger of a user or a stylus pen.

It is noted that in FIG. 1B the icon is directly displayed on the interface 13 by the touch display unit 12. In other embodiments, the icon may be implemented as an option in a tool menu not directly shown on the interface 13 and is displayed only when the tool menu is triggered.

Once the setting menu accessing command 15 is determined to be received by the touch display unit 12, the processing unit 14 retrieves one piece of the associating data 11 related to the active application in response to the setting menu accessing command 15. Subsequently, the processing unit 14 controls the touch display unit 12 to display a setting menu 19 including only the corresponding setting options 190 associated with the active application, as illustrated in FIG. 1C.

It is noted that in FIG. 1 B, the interface 13 of the web browser application is exemplarily illustrated. As a result, the menu 19 including the corresponding setting options 190 associated with the web browser application is displayed on the touch display unit 12 in FIG. 1C. In FIG. 1C, the corresponding setting options 190 that include a Wi-Fi activating option, a Bluetooth activating option, a privacy option, a security option and a cookies option are illustrated as an example. In other embodiments, the number and the content of the corresponding setting options 190 can be different.

In an embodiment, the processing unit 14 further receives an operating command (not shown) to operate one of the corresponding setting options 190 on the setting menu 19, and the processing unit 14 modifies an operation status of the handheld electronic device 1 accordingly.

In an embodiment, when the user switches the active application from the web browser to such as, but not limited to a media player application and the setting menu accessing command 15 is received, the processing unit 14 retrieves the related associating data 11 and controls the touch display unit 12 to display another menu including the corresponding setting options associated with the media player application.

As a result, the handheld electronic device 1 is able to display the setting menu 19 that only includes the setting options 190 corresponding to the active application. The user can easily select the corresponding setting options 190 and modify the operation status of the handheld electronic device 1 without being confused by the complex menu including the setting options unrelated to the active application. An intuitive operating mechanism of the handheld electronic device 1 is accomplished.

In an embodiment, the touch display unit 12 can further receive a modifying command (not shown) such that and the processing unit 14 modifies one of the pieces of the associating data 11 in the storage unit 10 to add at least one setting option to the corresponding setting options or delete the setting option from the corresponding setting options. For example, the modifying command can be used to add a setting option to the corresponding setting options 190 in the setting menu 19 first such that the processing unit 14 modifies the associating data 11 in the storage unit 10 subsequently. In other embodiments, other interfaces for modifying the associating data 11 can be used.

As a result, the user can decide the options that are needed or are not needed to be displayed in the menu 19 and dynamically modify the corresponding setting options displayed in the menu 19.

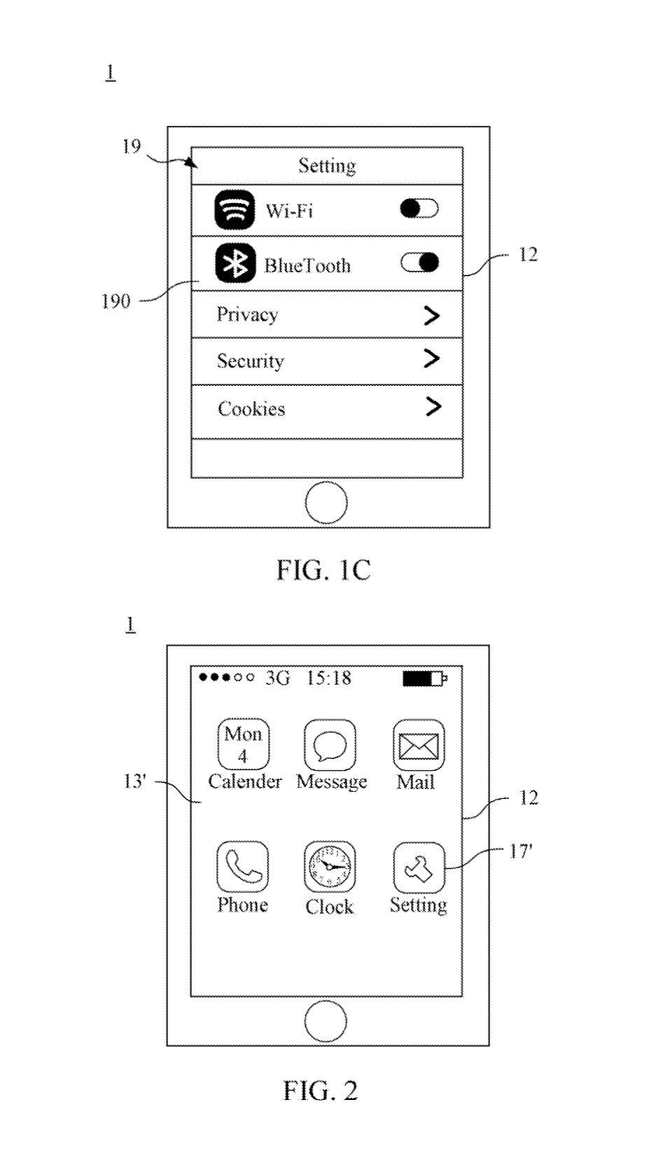

FIG. 2 is a top view of the handheld electronic device 1 in FIG. 1A in an embodiment of the present invention.

In an embodiment, the user may operate the handheld electronic device 1 to return to a frame of a desktop when the processing unit 14 executes the active application. The touch display unit 12 displays an interface 13′ of the desktop accordingly. The interface 13′ of the desktop includes an icon 17′ such that the touch display unit 12 receives the setting menu accessing command 15 by receiving an operation input applied on the icon 17′ of the interface 13′. As a result, it is not necessary to display the interface of the active application to receive the setting menu accessing command 15.

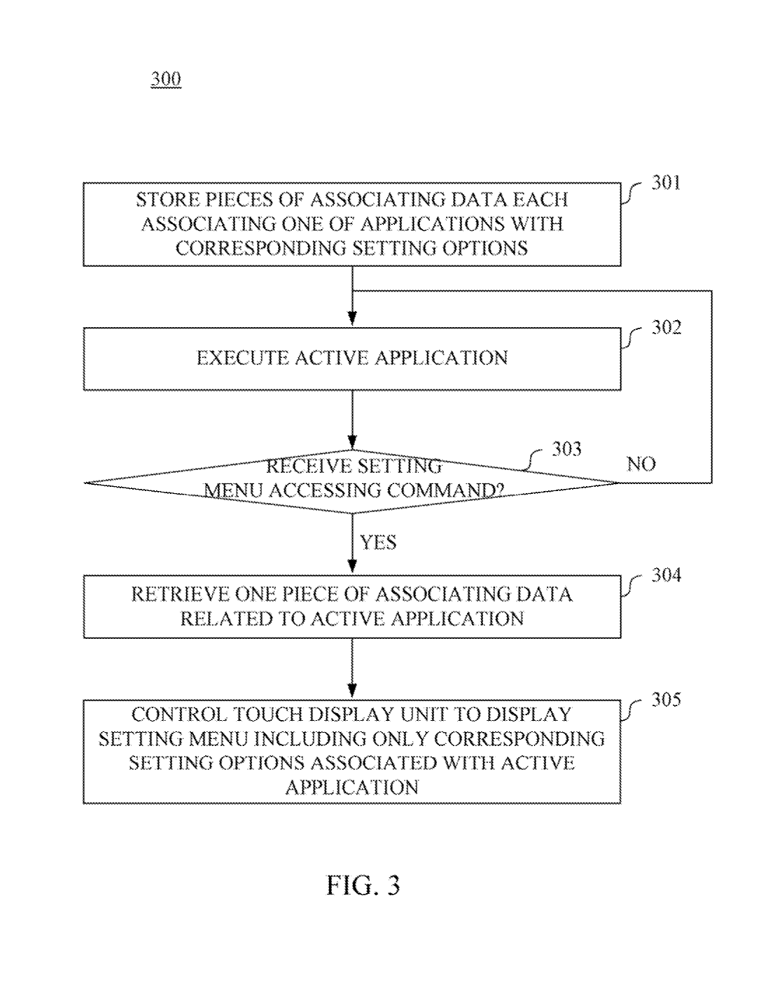

FIG. 3 is flow chart of a setting menu access method 300 of an embodiment of the present invention. The setting menu access method 300 is used in the handheld electronic device 1 illustrated in FIGS. 1A-1C and 2. The setting menu access method 300 includes the steps outlined below (The steps are not recited in the sequence in which the steps are performed. That is, unless the sequence of the steps is expressly indicated, the sequence of the steps is interchangeable, and all or part of the steps may be simultaneously, partially simultaneously, or sequentially performed).

In step 301, the pieces of associating data 11 each associating one of the applications with the corresponding setting options are stored by the storage unit 10.

In step 302, an active application of the plurality of applications is executed by the processing unit 14.

In step 303, the processing unit 14 determines whether a setting menu accessing command 15 is received by the touch display unit 12.

When the setting menu accessing command 15 is not received, the flow goes back to step 302 to execute the active application.

When the setting menu accessing command 15 is received, one piece of the associating data 11 related to the active application is retrieved in response to the setting menu accessing command 15 by the processing unit 14 in step 304.

In step 305, the touch display unit 12 is controlled to display the setting menu 19 including only the corresponding setting options 190 associated with the active application by the processing unit 14.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A handheld electronic device, comprising:
a storage unit to store a plurality pieces of associating data each associating one of a plurality of applications with a plurality of corresponding setting options;
a touch display unit; and
a processing unit electrically connected to the storage unit and the touch display unit, wherein the processing unit executes an active application of the plurality of applications, determines that the touch display unit receives a setting menu accessing command, retrieves one piece of the associating data related to the active application in response to the setting menu accessing command and controls the touch display unit to display a setting menu comprising only the corresponding setting options associated with the active application.

2. The handheld electronic device of claim 1, wherein the corresponding setting options are associated with the one of the plurality of applications according to a hardware access authority of the one of the plurality of applications.

3. The handheld electronic device of claim 1, wherein the corresponding setting option comprises at least one universal setting option.

4. The handheld electronic device of claim 2, wherein the universal setting option comprises a brightness setting option, a volume setting option, a device operation mode setting or a combination of the above.

5. The handheld electronic device of claim 1, wherein the touch display unit further receives a modifying command, and the processing unit modifies one of the pieces of the associating data in the storage unit to add at least one setting option to the corresponding setting options or delete the setting option from the corresponding setting options.

6. The handheld electronic device of claim 1, wherein the touch display unit displays an interface of the active application, wherein the touch display unit receives the setting menu accessing command by receiving an operation input applied on an icon of the interface.

7. The handheld electronic device of claim 1, wherein the touch display unit displays an interface of a desktop, wherein the touch display unit receives the setting menu accessing command by receiving an operation input applied on an icon of the interface.

8. The handheld electronic device of claim 1, wherein the touch display unit further receives an operating command to operate one of the corresponding setting options on the setting menu, and the processing unit modifies an operation status of the handheld electronic device according to the operating command.

9. A setting menu access method used in a handheld electronic device, the setting menu access method comprising:
storing a plurality pieces of associating data each associating one of a plurality of applications with a plurality of corresponding setting options by a storage unit;
executing an active application of the plurality of applications by a processing unit;
determining that a setting menu accessing command is received by a touch display unit by the processing unit; and
retrieving one piece of the associating data related to the active application in response to the setting menu accessing command by the processing unit; and
controlling the touch display unit to display a setting menu comprising only the corresponding setting options associated with the active application by the processing unit.

10. The setting menu access method of claim 9, wherein the corresponding setting options are associated with the one of the plurality of applications according to a hardware access authority of the one of the plurality of applications.

11. The setting menu access method of claim 9, wherein the corresponding setting options comprise at least one universal setting option.

12. The setting menu access method of claim 11, wherein the universal setting option comprises a brightness setting option, a volume setting option, a device operation mode setting or a combination of the above.

13. The setting menu access method of claim 9, further comprising:
receiving a modifying command by the touch display unit; and
modifying one of the pieces of the associating data in the storage unit by the processing unit to add at least one setting option to the corresponding setting options or delete the setting option from the corresponding setting options.

14. The setting menu access method of claim 9, further comprising:
displaying an interface of the active application by the touch display unit; and
receiving the setting menu accessing command by receiving an operation input applied on an icon of the interface.

15. The setting menu access method of claim 9, further comprising:
displaying an interface of a desktop by the touch display unit; and
receiving the setting menu accessing command by receiving an operation input applied on an icon of the interface.

16. The setting menu access method of claim 9, further comprising:
receiving an operating command by the touch display unit to operate one of the corresponding setting options on the setting menu; and
modifying an operation status of the handheld electronic device according to the operating command by the processing unit.
